(19) United States
(12) Patent Application Publication
(10) Pub. No.: US 2021/0019252 A1
(43) Pub. Date: Jan. 21, 2021

(54) INFORMATION PROCESSING APPARATUS, TEST MANAGEMENT METHOD, AND NON-TEMPORARY COMPUTER READABLE MEDIUM STORING PROGRAM

(71) Applicant: NEC CORPORATION, Tokyo (JP)

(72) Inventor: Mamoru FUJINE, Tokyo (JP)

(73) Assignee: NEC CORPORATION, Tokyo (JP)

(21) Appl. No.: 17/042,470

(22) PCT Filed: Oct. 12, 2018
(86) PCT No.: PCT/JP2018/038032

§ 371 Date: Sep. 28, 2020

(30) Foreign Application Priority Data
Mar. 30, 2018 (JP) 2018-067080

(51) Int. Cl. G06F 11/36; G06F 9/451

(52) U.S. Cl. CPC G06F 11/3684; G06F 9/451; G06F 11/3692; G06F 11/3688

(57) ABSTRACT

An information processing apparatus (1) includes a plurality of test data management tables (11 to 1n) for respective methods, a reception unit (31) that receives a designation of a first test pattern (21) from among the plurality of test patterns (21 to 2m) each defining a combination of a tool (211) supporting at least some of the plurality of methods, a parameter ID (212), and a GUI application (213) of a test target system, an acquisition unit (32) that acquires, as a parameter value, relevant test data (111) from the plurality of test data management tables (11 to 1n) based on the parameter ID (212) defined in the first test pattern (21), and a test execution unit (33) that executes a test on a GUI application (213) defined in the first test pattern (21) by the tool (211) defined in the first test pattern (21) using the parameter value.

### TECHNICAL FIELD

The present disclosure relates to an information processing apparatus, a test management method, and a program. In particular, the present disclosure relates to an information processing apparatus, a test management method, and a program for performing a test on GUI software using a tool for automating a GUI (Graphical User Interface) operation.

### BACKGROUND ART

In recent years, with the diversification of platforms such as devices and operating systems (Operating Systems), there has been an increase in the types of client applications accessing information systems that provide predetermined services via networks. The client application is usually operated by a user and is provided as a GUI application. More GUI applications than before are being tested with tools (GUI operation automation tool) that automate GUI operations based on RPA (Robotic Process Automation) technology.

Patent Literature 1 discloses a technique related to a test system for automating a test of a GUI program. A test system according to Patent Literature 1 acquires an event such as key input, mouse movement, or mouse click executed by a test operator, and stores image data in a file as an expected value when the event is an image storage event. The acquired information about the event is converted into a text-based test script. The test system inputs the test script at the time of a test and reproduces the event. When the reproduced event is an image storage event, the test system stores the image data in a file as a test result. After that, the test system compares the image data of the expected value with the image data of the test result, and verifies the test result.

### CITATION LIST

### Patent Literature

Patent Literature 1: Japanese Unexamined Patent Application Publication No. 2001-005690

### SUMMARY OF INVENTION

### Technical Problem

There are various kinds of GUI operation automation tools in addition to the one described in Patent Literature 1. In order to test a plurality of kinds of GUI applications supported by a certain information system, a plurality of kinds of tools may be combined. However, there has been a problem that it is difficult to efficiently link a plurality of kinds of GUI operation automation tools. This is because there is no mechanism for sharing parameters such as test data among the tools.

The present disclosure has been made to solve such a problem. An object the present disclosure is to provide an information processing apparatus, a test management method, and a program for efficiently linking a plurality of kinds of GUI operation automation tools.

### Solution to Problem

A first example aspect of the present disclosure is an information processing apparatus including:

a plurality of test data management tables for a plurality of respective methods to manage test data corresponding to each of the plurality of respective methods for automating a GUI (Graphical User Interface) operation;

a test pattern table for managing a plurality of test patterns, each of the test patterns defining a combination of a tool supporting at least some of the plurality of methods, a parameter ID, and a GUI application of a test target system;

a reception unit configured to receive a designation of a first test pattern from among the plurality of test patterns;

an acquisition unit configured to acquire, as a parameter value, relevant test data from the plurality of test data management tables based on the parameter ID defined in the first test pattern; and

a test execution unit configured to execute a test on a GUI application defined in the first test pattern by the tool defined in the first test pattern using the parameter value.

A second example aspect of the present disclosure is a test management method including:

receiving a designation of a first test pattern from among a plurality of test patterns, each of the plurality of test patterns defining a combination of a tool supporting at least some of a plurality of methods for automating an GUI (Graphical User Interface) operation, a parameter ID, and a GUI application of a test target system;

acquiring, as a parameter value, relevant test data from a plurality of test data management tables for a plurality of respective methods to manage test data corresponding to each of the plurality of respective methods based on the parameter ID defined in the first test pattern; and

executing a test on a GUI application defined in the first test pattern by the tool defined in the first test pattern using the parameter value.

A third example aspect of the present disclosure is a test management program for causing a computer to execute:

a processing of receiving a designation of a first test pattern from among a plurality of test patterns, each of the plurality of test patterns defining a combination of a tool supporting at least some of a plurality of methods for automating an GUI (Graphical User Interface) operation, a parameter ID, and a GUI application of a test target system;

a processing of acquiring, as a parameter value, relevant test data from a plurality of test data management tables for a plurality of respective methods to manage test data corresponding to each of the plurality of respective methods based on the parameter ID defined in the first test pattern; and

a processing of executing a test on a GUI application defined in the first test pattern by the tool defined in the first test pattern using the parameter value.

### Advantageous Effects of Invention

According to the present disclosure, it is possible to provide an information processing apparatus, a test management method, and a program for efficiently linking a plurality of kinds of GUI operation automation tools.

### BRIEF DESCRIPTION OF DRAWINGS

FIG. 1 is a block diagram showing a configuration of an information processing apparatus according to a first example embodiment;

FIG. 2 is a flowchart for explaining a flow of a test management method according to the first example embodiment;

FIG. 3 is a block diagram showing a configuration of a test management system according to a second example embodiment;

FIG. 4 is a diagram for explaining a concept of workflow information according to the second example embodiment;

FIG. 5 is a diagram for explaining a concept of a main attribute of each table and a relation between tables according to the second example embodiment.

FIG. 6 is a diagram for explaining a concept of a work scenario according to the second example embodiment;

FIG. 7 is a diagram for explaining a concept of a test scenario according to the second example embodiment;

FIG. 8 is a diagram for explaining an example of an automation method corresponding to the GUI operation automation tool according to the second example embodiment;

FIG. 9 is a flowchart for explaining a flow of registration processing according to the second example embodiment; and

FIG. 10 is a flowchart for explaining a flow of workflow execution processing according to the second example embodiment.

### DESCRIPTION OF EMBODIMENTS

Hereinafter, example embodiments of the present disclosure will now be described in detail with reference to the drawings. In each drawing, the same or corresponding elements are denoted by the same reference signs, and repeated description is omitted as necessary for clarification.

### First Example Embodiment

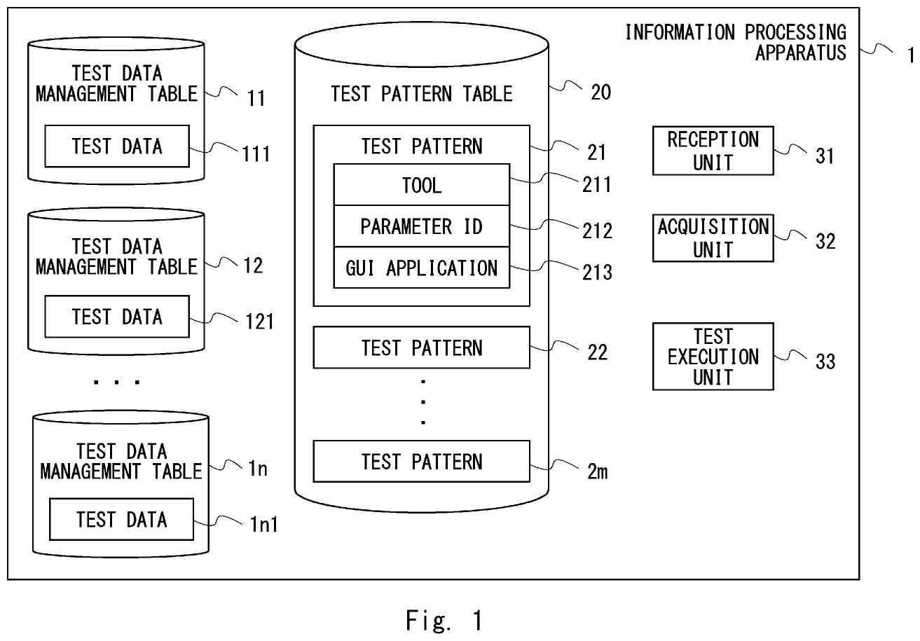

FIG. 1 is a block diagram showing a configuration of an information processing apparatus 1 according to the first example embodiment. The information processing apparatus 1 is a computer system for managing tests of GUI (Graphical User Interface) for a GUI application in a system to be tested. Thus, the information processing apparatus 1 may be implemented by a plurality of computers.

The information processing apparatus 1 includes test data management tables 11, 12, . . . 1n (n is a natural number greater than or equal to 2), a test pattern table 20, a reception unit 31, an acquisition unit 32, and a test execution unit 33. Each of the test data management tables 11 to 1n is a table for managing test data. The number of the test data management tables 11 and so forth may be at least two. For example, the test data management table 11 manages one or more pieces of test data 111, the test data management table 12 manages one or more pieces of test data 121, . . . and the test data management table In manages one or more pieces of test data 1n1. Each of the test data management tables 11 to 1n corresponds to each of a plurality of methods for automating GUI operations. Further, each of the test data 111, 121, . . . and 1n1 corresponds to each of a plurality of methods. For example, test data supporting the method A is stored in a test data management table for the method A. The test data supporting the method for automating the GUI operations is parameters used for (input to) the GUI operation automation tool described later. The test data is, for example, a parameter for causing the GUI operation automation tool to reproduce a predetermined GUI operation or information for verifying a GUI screen, which is a result of a response to a GUI operation. The test data includes, for example, coordinates indicating a position of a target GUI, object IDs of objects constituting the GUI, an image file for pattern matching or a file path of the image file, messages and parameters based on a predetermined protocol, character strings, setting values, and the like.

The test pattern table 20 manages a plurality of test patterns 21, 22, . . . 2m (m is a natural number greater than or equal to 2). The test pattern 21 is information defining a combination of a tool 211, a parameter ID 212, and a GUI application 213 of a system to be tested. The test patterns 22 to 2m are similar to the test pattern 21. The test pattern table 20 may manage at least two or more test patterns.

The tool 211 is information for specifying the GUI operation automation tool. Here, the GUI operation automation tool is a computer program which executes processing corresponding to a predetermined GUI operation using a predetermined parameter and verifies a GUI screen which is a response result by the GUI operation. The GUI operation automation tool supports at least some of the plurality of methods described above, i.e., supports one or more methods. Therefore, some methods may be common among a plurality of kinds of GUI operation automation tools. In such a case, it can be said that the test data can be shared between the tools supporting the common method. Note that the GUI operation automation tool may differ depending on the programming language used to implement the GUI application 213 to be operated, the type of information system to which the GUI application 213 belongs, and the platform (devices, OS, etc.) on which the GUI application 213 runs.

The parameter ID 212 is information for identifying a parameter value used for executing the GUI operation automation tool specified by the tool 211. The parameter ID 212 may be, for example, information for identifying any of the test data 111 to 1n1 described above or information for identifying other parameter values. A plurality of the parameter IDs 212 may be defined for each test pattern. That is, the test pattern and the parameter ID may have a one-to-many relationship.

The GUI application 213 is information for specifying a GUI application to be tested in regard to GUI by the tool 211. The GUI application 213 is a client application that accesses the system to be tested.

The reception unit 31 receives a designation of a first test pattern from among the plurality of test patterns 21 to 2m. For example, the reception unit 31 may receive a designation of the first test pattern when an execution of a test is instructed by a user's operation. Alternatively, the reception unit 31 may receive a designation of the first test pattern for a GUI test to be executed as part of a series of processing for the system to be tested.

The acquisition unit 32 acquires relevant test data as a parameter value from the plurality of test data management tables 11 to In based on the parameter ID defined in the first test pattern received by the reception unit 31.

The test execution unit 33 executes a test on the GUI application defined in the first test pattern by the tool defined in the first test pattern using the parameter value acquired by the acquisition unit 32.

The test data management tables 11 to 1n and the test pattern table 20 are stored in a storage apparatus (not shown) inside or outside the information processing apparatus 1. The reception unit 31, the acquisition unit 32, and the test execution unit 33 are implemented by a control unit in the information processing apparatus 1 reading and executing a test management program according to this example embodiment.

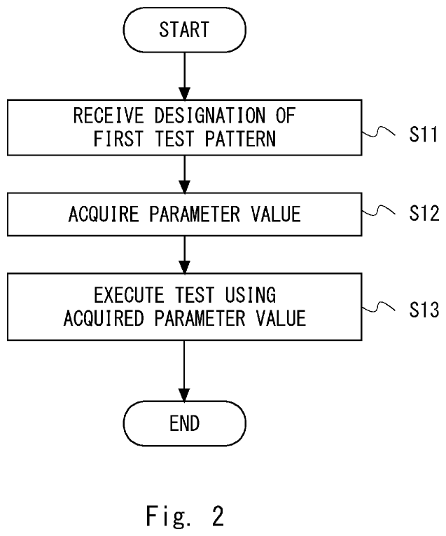

FIG. 2 is a flowchart for explaining a flow of a test management method according to the first example embodiment. First, the reception unit 31 receives a designation of a first test pattern (e.g., test pattern 21) from among the test patterns 21 to 2m in the test pattern table 20 (S11). Next, the acquisition unit 32 acquires the relevant test data (e.g., test data 111) from the test data management tables 11 to In as a parameter value based on the parameter ID 212 defined in the first test pattern (S12). After that, the test execution unit 33 executes a test for the GUI application 213 defined in the first test pattern by the tool 211 defined in the first test pattern using the acquired parameter value (test data 111) (S13).

As described above, in this example embodiment, the test data used for a GUI test on the GUI application in the test target system is managed by different tables for each automation method of a GUI operation. Thus, the test data for a

GUI test can be managed efficiently. When the plurality of GUI operation automation tools designate the same parameter ID, test data corresponding to a predetermined automation method can be easily shared. This is because some of the supported automation methods are often common among the plurality of GUI operation automation tools. Thus, a plurality of kinds of GUI operation automation tools can be efficiently linked to each other.

### Second Example Embodiment

A second example embodiment is an application example of the above-described first example embodiment. In the second example embodiment, various setting works for the target system and GUI tests corresponding to the setting works are linked. First, the parameter ID according to the second example embodiment includes a first test data ID for identifying a first combination of the method and the test data. In each of the plurality of test data management tables, the first test data ID is associated with the test data. The acquisition unit specifies a table corresponding to the method identified by the first test data ID from among the plurality of test data management tables, and acquires the test data associated with the first test data ID from the specified table as the parameter value. In this way, the table can be specified by the first test data ID using the first test data ID that can uniquely specify the table across the plurality of test data management tables. Therefore, by defining the first test data ID as the parameter ID, the test data can be read by accessing only the specified table. In this way, the processing of reading the test data can be efficiently executed.

A setting value management table (e.g., the following parameter sheet) in which a setting value used for setting processing (e.g., the following “work scenario”) for the test target system is associated with the test pattern may be further included. The parameter ID is one of the first test data ID and the setting value ID for identifying the setting value. In this case, when the parameter ID is the setting value ID, the acquisition unit acquires a setting value associated with the first test pattern from the setting value management table as the parameter value. Thus, by defining the setting value ID as the parameter ID, the setting value can be used at the time of checking the setting processing. By doing so, the accuracy of the verification of the GUI test can be improved. Further, since the first test data ID and the setting value ID can be defined equally as the parameter ID, flexibility in the definition of the test pattern is improved.

Furthermore, the reception unit receives a designation of the setting processing based on workflow information that defines a processing order of the setting processing and a processing order of tests in accordance with the first test pattern, and the acquisition unit acquires the setting value from the setting value management table based on the setting processing. In this case, the information processing apparatus further includes a setting unit for executing the setting processing on the test target system using the setting value. After the execution of the setting processing, the reception unit receives a designation of the first test pattern defined in the workflow information. This makes it possible to easily link the setting processing on the target system to the subsequent GUI test.

The plurality of test data management tables preferably include a first test data management table for managing structural data corresponding to a first method from among the plurality of methods as the test data, and a second test data management table for managing unstructural data corresponding to a second method from among the plurality of methods as the test data. Thus, a table can be efficiently designed according to the characteristics of the test data, and the maintainability can be improved.

The reception unit may further include a first registration unit that receives a second combination of the test data and the method, issues a second test data ID for identifying the second combination, specifies a table corresponding to the received method from among the plurality of test data management tables, and registers the second test data ID and the received test data in association with each other in the specified table. In this manner, the test data can be easily and efficiently registered by automatically issuing the test data ID that can identify the automation method.

The reception unit may further include a second registration unit that receives a third combination of the tool, the parameter ID, and the GUI application, generates a second test pattern defining the third combination, and registers the second test pattern in the test pattern table. By doing so, the parameter ID can be freely set in the test pattern.

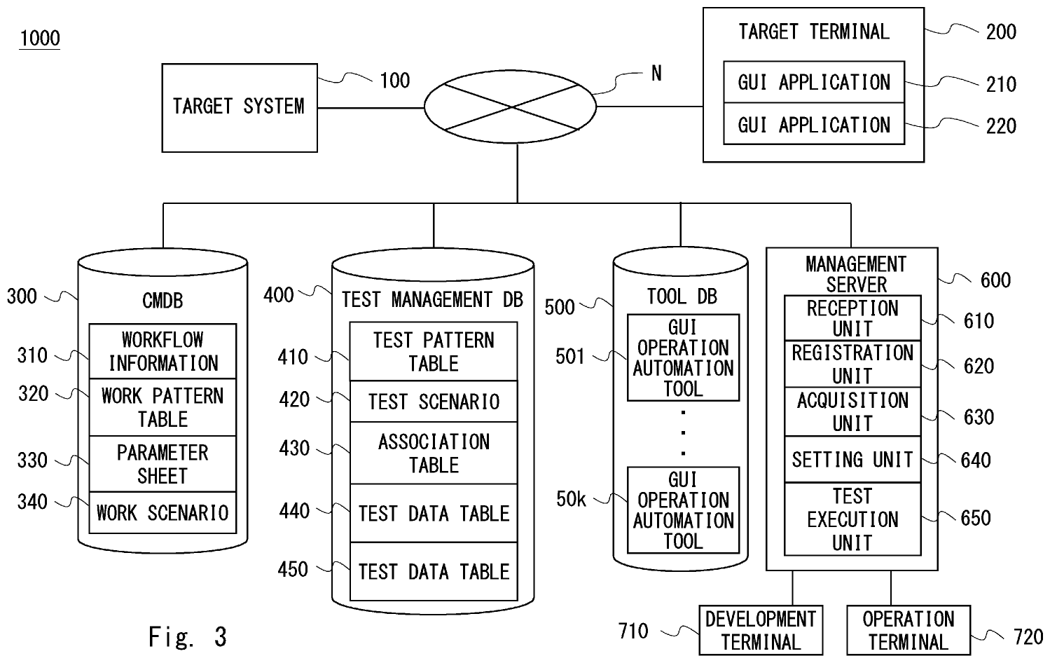

FIG. 3 is a block diagram showing a configuration of the test management system 1000 according to the second example embodiment. The test management system 1000 includes a target system 100, a target terminal 200, a CMDB (Configuration Management Database) 300, a test management DB (Database) 400, a tool DB 500, a management server 600, a development terminal 710, and an operation terminal 720. The target system 100, the target terminal 200, the CMDB 300, the test management DB 400, the tool DB 500, and the management server 600 are connected via a network N. The target system 100 is an information system that provides predetermined services. The target system 100 may include various IT systems. The target system 100 includes some or all of, for example, a cloud system, a network system, a storage system, a server system, and so on.

The target terminal 200 is a computer apparatus capable of operating the GUI applications 210 and 220. The target terminal 200 accesses the target system 100 via the network N and operates as a client terminal of the target system 100 by a CPU included therein reading and executing an OS and the GUI application 210 or 220. That is, the GUI applications 210 and 220 are client applications for the target system 100. The GUI applications 210 and 220 are, for example, dedicated client applications or browser software running on an OS for a PC. Alternatively, the GUI applications 210 and 220 are applications for smartphones that run on emulator software for emulating a smartphone or a tablet terminal. Therefore, like the target system 100, the GUI applications 210 and 220 are included in the information system to be developed and operated.

The CMDB 300 is a database for storing configuration information (design information) to be set in the target system 100. The configuration information of the CMDB includes various parameters to be set in the target system 100 and information about software to be implemented in the target system 100 (source code for interpreter, etc.). In addition to the configuration information, the CMDB 300 stores workflow information 310, a work pattern table 320, a parameter sheet 330, and a work scenario 340 for setting work and testing.

The workflow information 310 is information defining a processing order of the setting processing on the target system 100 and a processing order of the test on the GUI application 210 or 220 in accordance with the test pattern. The workflow information 310 can be regarded as information describing the flow of the operation work.

The work pattern table 320 is information defining an outline of the work pattern. The parameter sheet 330 is information defining a parameter value, which is a setting value set in the setting processing performed in a relevant work pattern. The parameter sheet 330 further associates a test pattern ID with the setting value in the work pattern. Thus, the parameter sheet 330 is a table in which a record is uniquely determined by a combination of a work pattern ID, a setting value ID, and a test pattern ID. The parameter sheet 330 is a table in which at least the work pattern ID (combination of the work pattern ID and the setting value ID) and the test pattern ID are associated in a many-to-many manner. It can thus be said that the parameter sheet 330 is information for managing the setting values to be used together in work and testing.

The work scenario 340 is information defining an order of operations to be performed in the setting processing defined in the work pattern and the setting value (parameter value) to be used in each operation.

The test management DB 400 is a database for managing definitions of tests for the target system 100 and the GUI applications 210 and 220. The test management DB 400 stores a test pattern table 410, a test scenario 420, an association table 430, a test data table 440, and a test data table 450. Note that the test pattern table 410 and the association table 430 are examples of the above-described test pattern table 20. The test data tables 440 and 450 are examples of the test data management tables 11 to 1n. Thus, in this example embodiment, the number of test data tables may be three or more.

The test pattern table 410 is information defining an outline of the test pattern. The test pattern table 410 includes, for each test pattern ID, definitions of associations such as identification information (tool ID) of a GUI operation automation tool to be used for a test, identification information of a target terminal on which a GUI test is executed, and identification information of a GUI application on which a GUI test is to be executed. On the other hand, the GUI operation automation tool uses a plurality of parameter values for one test pattern ID. That is, the relationship between the test pattern ID and the parameter ID is one-to-many. Therefore, the test pattern table 410 does not include the definition of the parameter ID.

The test scenario 420 is information defining the order of operations to be performed in the test processing defined in the test pattern and the parameter ID of the parameter value (setting value and test data) used for the verification processing. As the parameter ID, either the setting value ID or the test data ID may be used.

The association table 430 is a table in which the test pattern ID and the test data ID are associated in a many-to-many manner. The association table 430 may be provided for each of the test data tables 440 and 450 described later. This is for efficient processing for accessing the tables.

The test data table 440 is a table for managing the structural data from among the test data. The structural data is data having a specific structure, for example, data having a determined data type and size. One of the methods for automating GUI operations is a method in which structural data such as coordinates, object IDs, numerical values having a fixed number of decimal places and character strings having a fixed number of character strings are used as parameters. Thus, the test data table 440 can be said that it is an example of a first test data management table for managing the structural data corresponding to the first method from among the plurality of methods as the test data. In the test data table 440, the test data ID is associated with a test data value. The test data ID used in the test data table 440 is information for identifying a combination of a method using the structural data as a parameter and test data. Therefore, the test data ID can specify the test data table 440.

The test data table 450 is a table for managing the unstructural data from among the test data. The unstructural data is data other than the structural data and is, for example, an XML file or an image file. One of the methods for automating GUI operations is a method in which unstructural data such as an image file is used as a parameter. Therefore, the test data table 450 is an example of the second test data management table for managing the unstructural data corresponding to the second method from among the plurality of methods as the test data. In the test data table 450, the test data ID is associated with the test data value. The test data ID used in the test data table 450 is information for identifying a combination of a method using the unstructural data as a parameter and the test data. For this reason, the test data ID can specify the test data table 450.

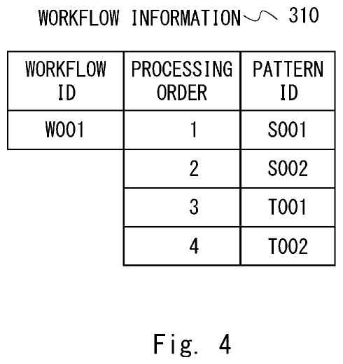

FIG. 4 is a diagram for explaining a concept of the workflow information 310 according to the second example embodiment. As shown in FIG. 4 as an example, the workflow information 310 can be expressed by defining an association of the pattern IDs of processes to be executed for each processing order with the workflow ID, which is the identification information of the workflow. The pattern ID in FIG. 4 is the work pattern ID or the test pattern ID. However, the pattern ID is not limited to them.

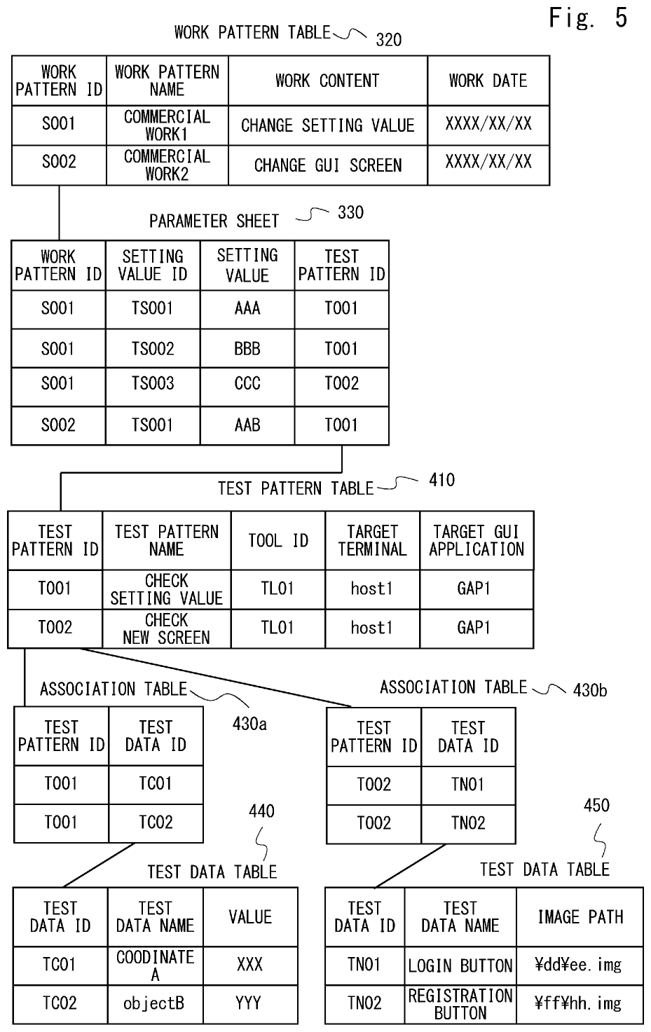

FIG. 5 is a diagram for explaining a concept of a main attribute of each table and a relation between the tables according to the second example embodiment. For example, the work pattern table 320 includes the work pattern ID, a work pattern name, a work content, and a work date as attributes. The parameter sheet 330 includes the work pattern ID, the setting value ID, the setting value, and the test pattern ID as attributes. The work pattern table 320 and the parameter sheet 330 are associated with each other in a one-to-many manner by the work pattern ID. The test pattern table 410 includes the test pattern ID, a test pattern name, the tool ID, the target terminal, and a target GUI application as attributes. The test pattern table 410 and the parameter sheet 330 are associated with each other in a one-to-many manner by the test pattern ID. Therefore, it can be said that the work pattern table 320 and the test pattern table 410 are also associated with each other in a many-to-many manner by the work pattern ID and the test pattern ID through the parameter sheet 330. The association tables 430a and 430b include the test pattern ID and the test data ID as attributes. The test data table 440 includes a test data ID, a test data name, and a value (test data value, which is structural data) as attributes. The test data table 450 includes the test data ID, the test data name, and an image path (link to the test data value, which is the unstructural data) as attributes. The test pattern table 410 and the test data table 440 are associated with each other in a one-to-many manner by the test pattern ID and the test data ID through the association table 430a. Likewise, the test pattern table 410 and the test data table 450 are associated with each other in a one-to-many manner by the test pattern ID and the test data ID through the association table 430b.

The setting value IDs of the parameter sheet 330 and the test data IDs of the test data tables 440 and 450 are indicated, as an example, by a code scheme such as “TSnnn”, “TCnn”, and “TNnn” (n is the number 0 to 9). Therefore, each of the setting value IDs and the test data IDs can be uniquely identified among all of the parameter sheet 330 and the test data tables 440 and 450. Further, “TCnn” and “TNnn” indicate that the test data in the table can be identified and the type of the table can also be identified.

FIG. 6 is a diagram for explaining a concept of the work scenario 340 according to the second example embodiment. As shown in FIG. 6 as an example, the work scenario 340 can be expressed by defining an association between an operation to be executed in each processing order and a parameter ID of a parameter value to be used in the operation, with respect to the work pattern ID that is identification information of the work scenario. The parameter ID set in the work scenario 340 here is the setting value ID as described above.

FIG. 7 is a diagram for explaining a concept of the test scenario 420 according to the second example embodiment. As shown in FIG. 7 as an example, the test scenario 420 can be expressed by defining an association between an operation to be executed in each processing order and a parameter ID of a parameter value to be used in the operation, with respect to the test pattern ID that is identification information of the test pattern. The parameter ID set in the test scenario 420 is the setting value ID or the test data ID as described above. That is, since the setting value used in the work pattern can be used also in the test pattern, more accurate data can be used as the expected value, thereby improving the accuracy of the verification processing. Further, data which is not registered in the parameter sheet 330 as a setting value and is used only in a test can be separately registered in the test data table. By adding such a test data table, the existing parameter sheet 330 can be efficiently managed without being affected. Further, since the appropriate data types of the test data are different depending on the characteristics of the data, the test data tables 440 and 450 are separated for each characteristic of the test data, thereby facilitating the management and improving the maintainability.

Note that the work scenario 340 and the test scenario 420 are not limited to those shown in FIGS. 6 and 7, but are held in any format such as a table or a file.

Referring back to FIG. 3, the description will be continued. The tool DB 500 is a database for managing a plurality of GUI operation automation tools 501 to 50k (k is a natural number greater than or equal to 2). Each of the GUI operation automation tools 501 and so forth is software capable of specifying a tool ID and performing processing for automating GUI operations.

Here, an example of the automation method supported by the GUI operation automation tool is outlined. First, as the automation method, there are, for example, a coordinate method, an object ID method, an image comparison method, a character recognition method, a protocol analysis method, and so on. The coordinate method is a method for operating an object based on position coordinates on a screen, and uses the position coordinates as an input. The object ID method is a method for recognizing and operating the object based on the object ID, which is property information set in the GUI object, and uses the object ID as an input. The image comparison method is a method of comparing images and recognizing and operating the object by pattern matching, and uses image data as an input. The character recognition method is a method of recognizing and operating an object based on the matching of a character string and an image, and uses image data as an input. The protocol analysis method is a method of recognizing whether access or a response is performed as expected by generating and analyzing a syntax based on a protocol such as HTTP (Hypertext Transfer Protocol), and uses script data or the like as an input. Thus, in this example, it can be said that the coordinate method and the object ID method use the structural data, and other method use the unstructural data. However, the automation methods may be classified by other standards, and methods other than those described above may be used.

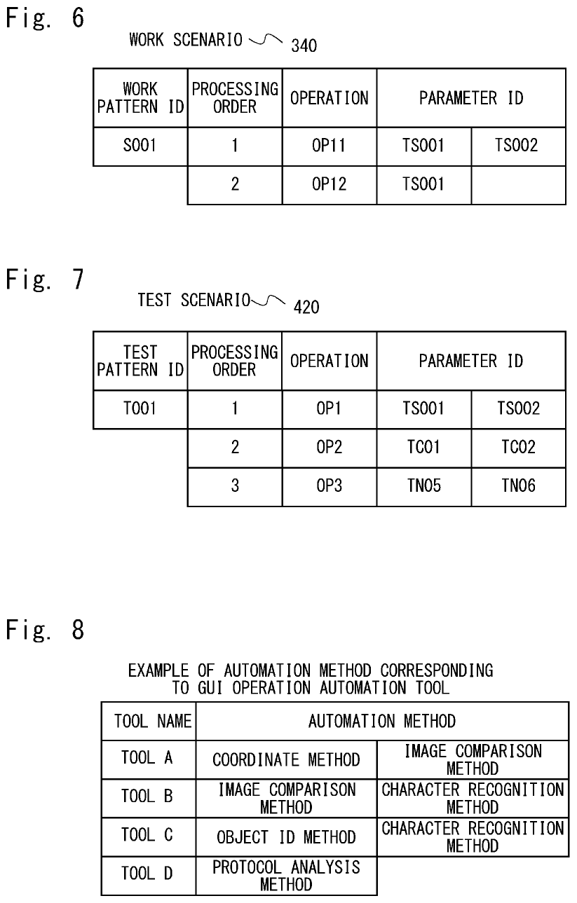

FIG. 8 is a diagram for explaining an example of an automation method corresponding to the GUI operation automation tool according to the second example embodiment. As described above, although there are various kinds of GUI operation automation tools and many kinds of automation methods, there is currently no tool that supports all the methods by a single tool. Thus, usually, a user needs to select and use a plurality of tools as appropriate according to the test contents and the characteristics of the tools. At this time, it is troublesome to prepare and set the test data for different tools separately in accordance with the interface for each tool, even if the test data for those tools is similar.

Here, in the example of FIG. 8, it is shown that the tools A and B are common in that they both support the image comparison method. It is also shown that tools B and C are common in that they both support the character recognition method. Therefore, it is possible to set a common test data ID between the tools A and B depending on the test contents. The same applies to the tools B and C.

This example embodiment makes it easy to reuse the test data in a plurality of GUI operation automation tools. Note that the correspondence relationship here is only for the purpose of explanation, and the actual correspondence relationship between the tools is not limited to them.

Referring back to FIG. 3, the description will be continued. The management server 600 is an information processing apparatus that manages the tests according to this example embodiment and executes the setting processing for the target system 100 and the GUI test for the GUI applications 210 and 220. The management server 600 may be implemented by a plurality of computers.

The management server 600 includes a reception unit 610, a registration unit 620, an acquisition unit 630, a setting unit 640, and a test execution unit 650. The reception unit 610 is an example of the reception unit 31 described above. The reception unit 610 receives a request from the development terminal 710 or the operation terminal 720 and outputs the request to the registration unit 620, the acquisition unit 630 or the like. Alternatively, the reception unit 610 reads the workflow information 310 at a predetermined time or the like, and receives a designation of the pattern ID defined in the workflow information 310.

When the reception unit 610 receives registration information, the registration unit 620 determines the type of the registration information and performs processing of registering the content of the registration information in a table corresponding to the type. The acquisition unit 630 is an example of the acquisition unit 32 described above. The acquisition unit 630 acquires the parameter value corresponding to the parameter ID, for example, the setting value and test data, based on the work pattern or the test pattern corresponding to the designated pattern ID. The setting unit 640 executes the setting processing on the target system 100 via the network N using the setting value acquired when the pattern ID is indicated by the work pattern. The test execution unit 650 is an example of the test execution unit 33 described above. That is, the test execution unit 650 executes a test for the GUI application 210 or 220 in the target terminal 200 via the network N using the acquired test data or the setting value based on the test pattern indicated by the pattern ID. Note that the reception unit 610, the registration unit 620, the acquisition unit 630, the setting unit 640, and the test execution unit 650 are implemented by a CPU (not shown) in the management server 600 reading and executing the test management program according to this example embodiment.

The development terminal 710 is a terminal apparatus in which a developer performs an operation necessary for the development work, and is, for example, a personal computer. The development terminal 710 is communicably connected to the management server 600 via a network or the like, and accesses the management server 600 to input information or the like in response to an operation of the developer.

The operation terminal 720 is a terminal apparatus in which an operator performs an operation necessary for operation work (including maintenance work), and is, for example, a personal computer. The operation terminal 720 is communicably connected to the management server 600 via a network or the like, and accesses the management server 600 to input information or the like in response to an operation of the operator.

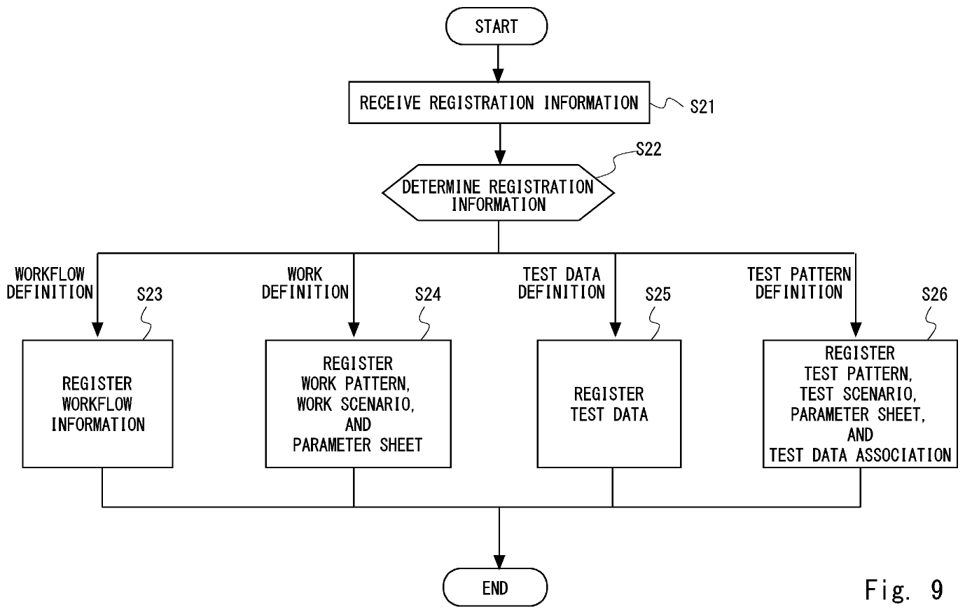

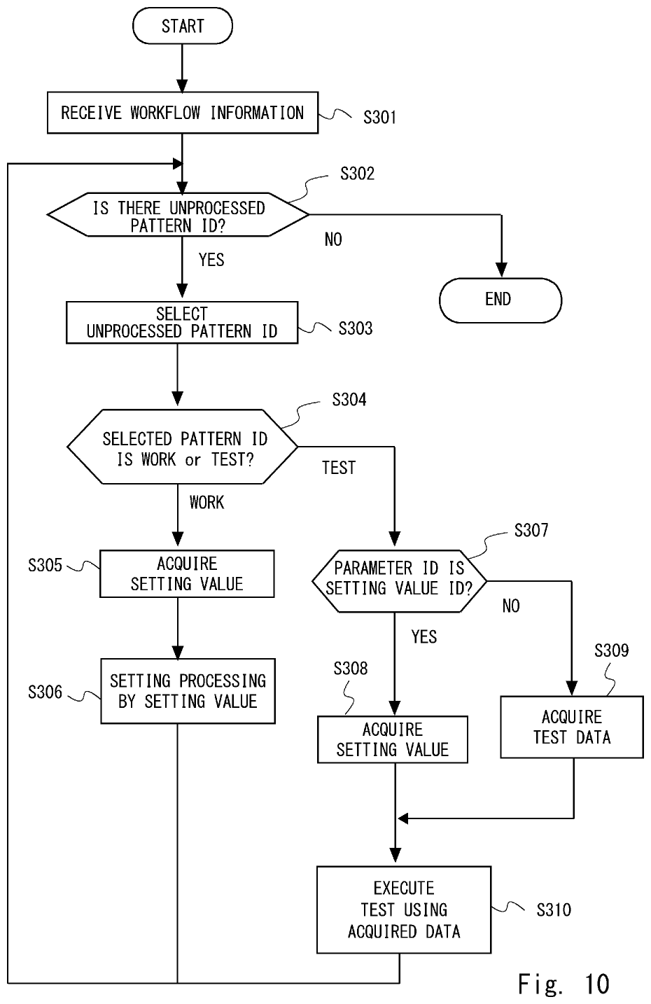

FIG. 9 is a flowchart for explaining a flow of the registration processing according to the second example embodiment. First, the reception unit 610 receives the registration information from the development terminal 710 or the operation terminal 720 (S21). For example, the operation terminal 720 transmits the registration information input by the user's operation as a registration request to the management server 600. The registration information includes, for example, information for defining or updating a workflow, information for defining or updating a work pattern, information for defining or updating test data, information for defining or updating a test pattern, and the like. The information such as the definition of the test data is a combination of the test data and the automation method. The information such as the definition of the test pattern is a combination of a list of tool IDs and parameter IDs and a GUI application ID.

Next, the registration unit 620 determines the contents of the registration information received by the reception unit 610 (S22). If it is determined in Step S22 that the registration information is a definition of the workflow, the registration unit 620 registers the workflow information 310 in the CMDB 300 based on the registration information (S23). For example, the registration unit 620 registers or updates the pattern ID for each processing order for the corresponding workflow ID.

If it is determined in Step S22 that the registration information is a definition of the work pattern or the like, the registration unit 620 registers the work pattern or the like in the CMDB 300 based on the registration information (S24). For example, the registration unit 620 registers or updates the work pattern table 320, the parameter sheet 330, and the work scenario 340.

When it is determined in Step S22 that the registration information is a definition of the test data, the registration unit 620 registers the test data in the test management DB 400 based on the registration information (S25). For example, the registration unit 620 issues a test data ID for identifying a combination of the test data included in the registration information and the automation method. However, it is assumed that the automation method is associated with the test data table 440 or 450. That is, it is assumed that the test data can be classified into either the test data table 440 or the test data table 450 by the automation method. The registration unit 620 specifies either the test data table 440 or 450 by the issued test data ID. After that, the registration unit 620 registers the test data included in the registration information and the issued test data ID in association with each other in the specified table.

If it is determined in Step S22 that the registration information is a definition of the test pattern or the like, the registration unit 620 registers the test pattern or the like in the test management DB 400 based on the registration information (S26). For example, the registration unit 620 registers or updates the test pattern table 410, the test scenario 420, and the association table 430. The registration unit 620 also updates the parameter sheet 330 as necessary. For example, the registration unit 620 registers the test pattern ID, the test pattern name, the tool ID, the target terminal, and the target GUI application in association with each other in the test pattern table 410. The registration unit 620 associates the test pattern ID with each of the plurality of test data IDs and registers them in the association table 430a or 430b. The registration unit 620 registers or updates the parameter ID in the test scenario 420 for each processing order with respect to the test pattern ID.

FIG. 10 is a flowchart for explaining a flow of the workflow execution processing according to the second example embodiment. First, the reception unit 610 receives the workflow information (S301). For example, the reception unit 610 receives an execution request specifying the workflow ID from the operation terminal 720, and reads out the workflow information 310 corresponding to the specified workflow ID from the CMDB 300. Alternatively, the reception unit 610 reads the workflow information 310 from the CMDB 300 at a preset time.

Next, the reception unit 610 determines whether there is an unprocessed pattern ID defined in the target workflow information 310 (S302). When the unprocessed pattern ID is included, the reception unit 610 selects the one having the smallest processing order among the unprocessed pattern IDs defined in the target workflow information 310 (S303). Then, the acquisition unit 630 determines whether the selected pattern ID is the work pattern or the test pattern (S304).

In Step S304, if the selected pattern ID is the work pattern, the acquisition unit 630 refers to the work scenario 340 corresponding to the selected work pattern ID, and specifies the parameter ID (setting value ID) associated with each operation. Then, the acquisition unit 630 acquires the setting value associated with each specified setting value ID from the parameter sheet 330 (S305). At this time, the acquisition unit 630 specifies the combination of the work pattern ID, the setting value ID, and the test pattern ID by referring to the definition of the workflow information 310 and the association table of the work pattern ID and the test pattern ID separately, and acquires the setting value from the parameter sheet 330 using the specified combination. After that, the setting unit 640 executes the setting processing corresponding to each operation on the target system 100 using the acquired setting value (S306). Then, the process returns to Step S302.

When the selected pattern ID is a test pattern in Step S304, the acquisition unit 630 refers to the test scenario 420 corresponding to the selected test pattern ID, and specifies each parameter ID associated with each operation. Then, for each of the specified parameter IDs, the acquisition unit 630 determines whether the parameter ID is the setting value ID or the test data ID (S307). If the parameter ID is the setting value ID, the acquisition unit 630 acquires the setting value associated with the setting value ID from the parameter sheet 330 (S308). At this time, the acquisition unit 630 specifies the combination of the work pattern ID, the setting value ID, and the test pattern ID by referring to the definition of the workflow information 310 and the association table of the work pattern ID and the test pattern ID separately, and acquires the setting value from the parameter sheet 330 using the specified combination.

When the parameter ID is the test data ID in Step S307, the acquisition unit 630 specifies either the test data table 440 or 450 based on the test data ID, and acquires the test data associated with the test data ID from the specified table.

For each parameter ID, Step S308 or Step S309 is performed to acquire the setting value and the test data. After that, the test execution unit 650 executes a test using the acquired data (S310). That is, the test execution unit 650 reads the GUI operation automation tool 501 or the like corresponding to the tool ID associated with the selected test pattern ID from the tool DB 500. Next, the test execution unit 650 specifies the target terminal and the target GUI application associated with the selected test pattern ID. Then, the test execution unit 650 designates the acquired setting value and test data as the parameter for the read GUI operation automation tool, and controls a test to be executed on the specified target terminal for the specified target GUI application. At this time, the test execution unit 650 appropriately converts, processes, or performs other processing on the acquired setting value and test data according to the interface of the GUI operation automation tool. Then, the process returns to Step S302.

In Step S302, if all the pattern IDs defined in the target workflow information 310 have been processed (selected), the process ends.

As described above, according to this example embodiment, various setting operations for the target system and corresponding GUI tests can be linked. In particular, the setting value used in the setting processing can be used as the parameter for the GUI test and shared. Further, the test data corresponding to the supported method can be shared among the plurality of GUI operation automation tools. In this manner, a plurality of kinds of GUI operation automation tools can be efficiently linked.

### Other Example Embodiment

In the above example embodiments, the configuration of the hardware is described, but the present disclosure is not limited to this. The present disclosure can also be implemented by causing a CPU (Central Processing Unit) to execute a computer program.

In the above examples, the program may be stored and provided to a computer using various types of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments, and may be modified as appropriate without departing from the scope thereof. The present disclosure may be implemented by appropriately combining the respective example embodiments.

Although the present disclosure has been described with reference to the example embodiments, the present disclosure is not limited by the above-described example embodiments. The configuration and details of the present disclosure may be modified in various ways as will be understood by those skilled in the art within the scope of the invention.

This application is based upon and claims the benefit of priority from Japanese patent application No. 2018-067080, filed on Mar. 30, 2018, the disclosure of which is incorporated herein in its entirety by reference.

### REFERENCE SIGNS LIST

1 INFORMATION PROCESSING APPARATUS

11 TEST DATA MANAGEMENT TABLE

111 TEST DATA

12 TEST DATA MANAGEMENT TABLE

121 TEST DATA

1n TEST DATA MANAGEMENT TABLE

1n1 TEST DATA

20 TEST PATTERN TABLE

21 TEST PATTERN

211 TOOL

212 PARAMETER ID

213 GUI APPLICATION

22 TEST PATTERN

2m TEST PATTERN

31 RECEPTION UNIT

32 ACQUISITION UNIT

33 TEST EXECUTION UNIT

1000 TEST MANAGEMENT SYSTEM

100 TARGET SYSTEM

N NETWORK

200 TARGET TERMINAL

210 GUI APPLICATION

220 GUI APPLICATION

300 CMDB

310 WORKFLOW INFORMATION

320 WORK PATTERN TABLE

330 PARAMETER SHEET

340 WORK SCENARIO

400 TEST MANAGEMENT DB

410 TEST PATTERN TABLE

420 TEST SCENARIO

430 ASSOCIATION TABLE

440 TEST DATA TABLE

450 TEST DATA TABLE

500 TOOL DB

501 GUI OPERATION AUTOMATION TOOL

501 GUI OPERATION AUTOMATION TOOL

600 MANAGEMENT SERVER

610 RECEPTION UNIT

620 REGISTRATION UNIT

630 ACQUISITION UNIT

640 SETTING UNIT

650 TEST EXECUTION UNIT

710 DEVELOPMENT TERMINAL

720 OPERATION TERMINAL

1. An information processing apparatus comprising:
at least one memory storing
instructions,
a plurality of test data management tables for a plurality of respective methods to manage test data corresponding to each of the plurality of respective methods for automating a GUI (Graphical User Interface) operation; and
a test pattern table for managing a plurality of test patterns, each of the test patterns defining a combination of a tool supporting at least some of the plurality of methods, a parameter ID, and a GUI application of a test target system; and
at least one processor configured to execute the instructions to:
receive a designation of a first test pattern from among the plurality of test patterns;
acquire, as a parameter value, relevant test data from the plurality of test data management tables based on the parameter ID defined in the first test pattern; and
execute a test on a GUI application defined in the first test pattern by the tool defined in the first test pattern using the parameter value.

2. The information processing apparatus according to claim 1, wherein
the parameter ID includes a first test data ID for identifying a first combination of the method and the test data, and
each of the plurality of test data management tables is associated with the first test data ID and the test data, and
wherein the at least one processor further configured to execute the instructions to
specify a table corresponding to the method identified by the first test data ID from among the plurality of test data management tables and acquires, as the parameter value, the test data associated with the first test data ID from the specified table.

3. The information processing apparatus according to claim 2,
wherein the at least one memory further storing a setting value management table associating a setting value used for setting processing in the test target system with the test pattern, and wherein
the parameter ID is either the first test data ID or a setting value ID for identifying the setting value, and
wherein the at least one processor further configured to execute the instructions to
acquire, as the parameter value, the setting value associated with the first test pattern from the setting value management table when the parameter ID is the setting value ID.

4. The information processing apparatus according to claim 3, wherein
the at least one processor further configured to execute the instructions to
receive a designation of the setting processing based on workflow information defining a processing order of the setting processing and the test by the first test pattern,
acquire the setting value from the setting value management table based on the setting processing,
execute the setting processing on the test target system using the setting value, and
receive a designation of the first test pattern defined in the workflow information after the execution of the setting processing.

5. The information processing apparatus according to claim 1, wherein
the plurality of test data management tables include a first test data management table for managing, as the test data, structural data corresponding to a first method from among the plurality of methods and a second test data management table for managing, as the test data, unstructural data corresponding to a second method among the plurality of methods.

6. The information processing apparatus according to claim 1, wherein the at least one processor further configured to execute the instructions to
receives a second combination of the test data and the method, and
issue a second test data ID for identifying the second combination, specifying a table corresponding to the received method from among the plurality of test data management tables, and registers the second test data ID and the received test data in association with each other in the specified table.

7. The information processing apparatus according to claim 1, wherein the at least one processor further configured to execute the instructions to
receive a third combination of the tool, the parameter ID, and the GUI application, and
generate a second test pattern defining the third combination and registering the second test pattern in the test pattern table.

8. A test management method comprising:
receiving a designation of a first test pattern from among a plurality of test patterns, each of the plurality of test patterns defining a combination of a tool supporting at least some of a plurality of methods for automating an GUI (Graphical User Interface) operation, a parameter ID, and a GUI application of a test target system;
acquiring, as a parameter value, relevant test data from a plurality of test data management tables for a plurality of respective methods to manage test data corresponding to each of the plurality of respective methods based on the parameter ID defined in the first test pattern; and
executing a test on a GUI application defined in the first test pattern by the tool defined in the first test pattern using the parameter value.

9. A non-transitory computer readable medium storing a test management program for causing a computer to execute:
a processing of receiving a designation of a first test pattern from among a plurality of test patterns, each of the plurality of test patterns defining a combination of a tool supporting at least some of a plurality of methods for automating an GUI (Graphical User Interface) operation, a parameter ID, and a GUI application of a test target system;
a processing of acquiring, as a parameter value, relevant test data from a plurality of test data management tables for a plurality of respective methods to manage test data corresponding to each of the plurality of respective methods based on the parameter ID defined in the first test pattern; and
a processing of executing a test on a GUI application defined in the first test pattern by the tool defined in the first test pattern using the parameter value.
